(19) United States
(12) Patent Application Publication
(10) Pub. No.: US 2025/0283294 A1
(43) Pub. Date: Sep. 11, 2025

(54) ROTARY AND/OR SWIVEL UNIT

(71) Applicant: OilQuick Deutschland KG, Steindorf (DE)

(72) Inventor: Stefan SCHAUER, Kissing (DE)

(73) Assignee: OilQuick Deutschland KG, Steindorf (DE)

(21) Appl. No.: 19/023,686

(22) Filed: Jan. 16, 2025

(30) Foreign Application Priority Data
Mar. 5, 2024 (DE) 10 2024 106 244.4

(51) Int. Cl. E02F 3/36

(52) U.S. Cl. CPC E02F 3/3681; E02F 3/3663

(57) ABSTRACT

A rotary and/or swivel unit for attachment to a construction machine contains a connection part and a support arranged movable on the connection part for a tool or a quick changer for coupling a tool or attachment. The support is arranged on the connection part so as to be rotatable by a motor around an axis of rotation by means of a rotary drive and/or tiltable around a pivot axis by means of a pivot drive. The rotary and/or swivel unit has a central lubricant supply with an automatically actuated lubricant pump provided with a lubricant reservoir for delivering lubricant to different lubricating points.

### FIELD OF THE INVENTION

The invention relates to a rotary and/or swivel unit for attachment to a construction machine.

### BACKGROUND OF THE INVENTION

Such rotary and/or swivel units are used on excavators or other comparable construction machines between an attachment of the construction machine and the tool as a rotary and/or swivel unit to expand the range of movement. Such rotary and swivel units ordinarily contain a connection part mountable on the construction machine and a support arranged movable on the connection part for coupling a tool or attachment in which the support is arranged on the connection part so as to be rotatable by a motor around an axis of rotation by means of a rotary drive and/or tiltable by means of a pivot drive around a pivot axis orthogonal to the axis of rotation. A combined rotary and/or swivel unit also referred to as a tiltrotator is also known from DE 10 2020 127 313 B3. In this case, the support of a quick changer is arranged rotatable around an axis of rotation by means of a hydraulic rotary drive and pivotable around a pivot axis orthogonal to the axis of rotation by means of a hydraulic pivot drive on a connection part mountable on an excavator. Such a tiltrotator enables the attachments connected to the quick changer, for example, tilting buckets, grapples, shears, compactors, magnets, hydraulic hammers or the like, to be rotated not only around a pivot axis arranged transversely the longitudinal axis of an excavator boom, but also around an axis of rotation orthogonal to this pivot axis.

Rotary and/or swivel units of the aforementioned type ordinarily have a number of different lubricating points, which must be lubricated regularly to ensure proper operation and to avoid wear. However, regular lubrication during daily operation is often neglected or forgotten, which can lead to undesired wear and the related damage and disruptions in operation.

### SUMMARY OF THE INVENTION

One aspect of the invention relates to a rotary and/or swivel unit of the aforementioned type, which ensures regular lubrication of the different lubricating points even without a separate intervention.

Useful embodiments and advantageous modifications of the invention are disclosed herein.

The rotary and/or swivel unit according to the invention contains a connection part mountable on a construction machine and a support arranged movable on the connection part for connecting a tool or attachment, in which case the support is arranged on the connection part so as to be rotatable by a motor around an axis of rotation by means of a rotary drive and/or tiltable around a pivot axis by means of a pivot drive. The rotary and/or swivel unit also contains a central lubricant supply with an automatically actuated lubricant pump provided with a lubricant reservoir. The automatically actuated lubricant pump arranged on the rotary and/or swivel unit enables the different lubricating points of the rotary and/or swivel unit to be supplied with a lubricant provided in a lubricant reservoir even without a lubricant connection to a central lubricating system on the construction machine and without any separate intervention by the operator. the lubricant pump can be activated automatically, for example, when the rotary and/or swivel drive is actuated or when the construction machine is started. This means that the lubrication of the different lubricating points, which is essential for preventing wear, cannot be overlooked. Owing to the fact that the lubricant supply to the rotary and/or swivel unit is independent of the central lubricating system of the construction machine and integrated into the rotary and/or swivel unit, no lubricant lines and specially designed couplings are necessary between the rotary and/or swivel unit and a central lubricating system provided on the construction machine.

In a particularly useful variant, a housing part is arranged on a connection part, which is mounted so as to be pivotable around a pivot axis and tiltable by means of a pivot drive in which the support is rotatably mounted around an axis of rotation orthogonal to the pivot axis, and which can be rotated by a motor by means of the rotary drive. Such a rotary and swivel unit, referred to as a tiltrotator, enables the attachments connected to the rotary and swivel unit, for example, tilting buckets, grapples, shears, compactors, magnets, hydraulic hammers or the like, to be rotated not only around the pivot axis arranged transversely to the longitudinal axis of the excavator boom, but also around an axis of rotation orthogonal to this pivot axis.

In a particularly useful variant, the lubricant pump is connected via a supply line to a distributor to distribute the lubricant delivered by the lubricant pump to the different lubricating points. This enables the lubricant to reach the corresponding lubricating points in a predetermined manner. The amount of lubricant that the individual lubricating points require can be stipulated via the distributor unit. Several lubricant supply lines leading to the different lubricating points are connected to the distributor unit.

A lubricant amount regulation device for adjusting the amount of lubricant delivered by the lubricant pump when same is activated is expediently arranged on the lubricant pump. This makes it possible to adjust the amount of lubricant delivered by the lubricant pump from the lubricant reservoir when the pump is activated.

The lubricant pump can be arranged on or adjacent to the housing part of the rotary and/or swivel unit tiltable around the pivot axis. The distributor unit is also preferably arranged on or adjacent to the housing part tiltable around the pivot axis.

In a particularly advantageous variant, the lubricant pump can be designed as a hydraulically operated lubricant pump with a hydraulically operated pump piston. However, the lubricant pump can also be electrically operated and activated, for example, by an electric control when the construction machine is started. Regular lubrication of the rotary and/or swivel unit can also thereby be ensured.

The lubricant pump can expediently be activated by controlling the pivot drive or by controlling the rotary drive. In a hydraulic rotary and pivot drive and a hydraulically operating lubricant pump, the lubricant pump can be connected via a bypass line to a hydraulic circuit H2 for controlling the pivot drive or a hydraulic circuit H1 for controlling the rotary drive.

The rotary drive can include a hydraulic motor that can be controlled by the first hydraulic circuit H1 and the pivot drive can be formed by two double-acting actuating cylinders movable in opposite directions and controllable by the second hydraulic circuit H2.

A quick changer designed for connecting a tool can be arranged on the support. However, a grapple or other tool can also be directly arranged on the support. The support can also be designed as the housing of a quick changer.

The connection part can contain two spaced-apart pin-like coupling elements for coupling the connection part to a quick changer. The connection part and thus the rotary and/or swivel unit can therefore be connected via a quick changer to an excavator boom and used in a sandwich assembly with an additional lower quick changer for automatically changing attachments. However, the connection part can also be permanently attached to an excavator arm.

### BRIEF DESCRIPTION OF THE DRAWINGS

Further details and advantages of the invention will become apparent from the following description of preferred embodiments with reference to the drawing. In the drawing:

FIG. 1 shows a rotary and swivel unit with a quick changer and an automatic lubricant supply in a first perspective view;

FIG. 2 shows an enlarged detailed view of the rotary and swivel unit of FIG. 1; and

FIG. 3 shows a hydraulic circuit arrangement for controlling the automatic lubricant supply of the rotary and swivel unit shown in FIGS. 1 and 2.

### DETAILED DESCRIPTION

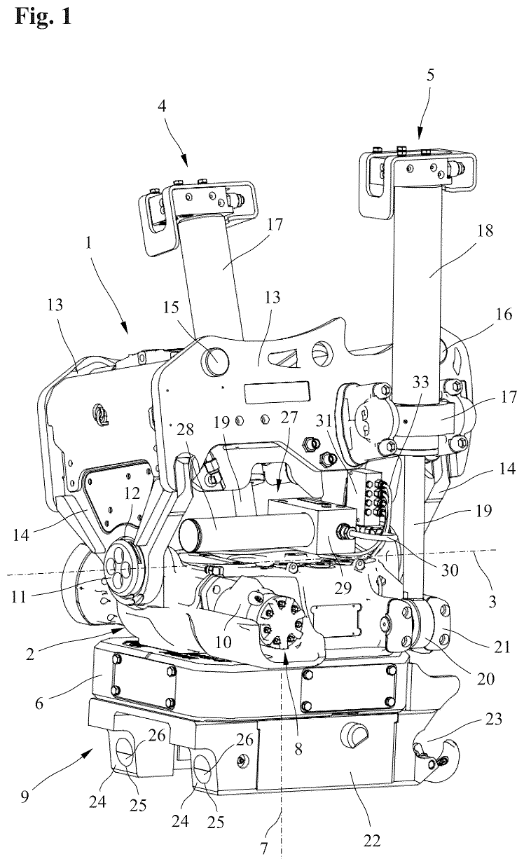

The rotary and swivel unit shown in a perspective view in FIG. 1 and also referred to as a tiltrotator contains a connection part 1 mountable either directly or via a hydraulically operated quick changer on an excavator boom or another attachment of a construction machine, on which a housing part 2 is mounted to pivot around the pivot axis 3 and arranged tiltable around the pivot axis 3 by means of a pivot drive which, in this case, is formed by two hydraulic actuating cylinders 4 and 5. In the housing part 2 tiltable relative to connection part 1, a support 6 is rotatably mounted around an axis of rotation 7 orthogonal to the pivot axis 3 and can be rotated 360° by means of a rotary drive 8. In the embodiment shown, a quick changer 9 designed for connecting a tool is arranged on the support 6. However, a grapple or other tool can be directly arranged on the support 6. In addition, the support 6 can also be designed as the housing of a quick changer.

The rotary drive 8, which is designed here as a hydraulic drive, contains a hydraulic motor 10 by means of which the support 6 can be rotated by a motor around the axis of rotation 7. by 360° relative to the housing part 2, via a gear mechanism with a worm gear arranged inside the housing part 2 and a worm drive rotatable by the hydraulic motor 10.

The housing part 2 is arranged on connection part 1 via laterally protruding journals 11 inside two spaced-apart bearing lugs 12 so as to be pivotable around the pivot axis 3, which is orthogonal to axis of rotation 7, and can be pivoted by approximately +/−45° around the pivot axis 3, relative to the connection part 1, via the hydraulic pivot drive formed by the two actuating cylinders 4 and 5. The attachments connected to the quick changer 9 can not only be rotated around the axis of rotation 7 by the tiltrotator which is also referred to as a rotary-pivot drive, but also tilted relative to connection part 1 around the pivot axis 3 orthogonal to axis of rotation 7, thereby expanding the range of movement increasing the area of application.

In the embodiment shown, the connection part 1 has two parallel side walls 13 as well as front and rear crosspieces 14 with the bearing lugs 12 arranged thereon. The housing part 2 is mounted to pivot around the pivot axis 3 via the two journals 11 inside the bearing lugs 12 of the front and rear crosspieces 14. Two parallel and spaced-apart pin-like coupling elements 15 and 16 for connecting to a hydraulically operated quick changer (not shown here) arranged on the construction machine are arranged in the two side walls 13 of the connection part 1 shown.

An embodiment of a hydraulically operable quick changer arranged on an excavator arm or other construction machine for automatically connecting the tiltrotator is disclosed in DE 10 2018 128 479 A1. This document is explicitly referred to with regard to the known design and method of operation of such a hydraulically operable quick changer. However, the connection part 1 could also be directly mounted on a boom and a coupling of an excavator without the intermediate connection of a hydraulically operated quick changer.

In the embodiment shown, the pivot drive is formed by the double-acting actuating cylinders 4 and 5, each having a cylinder housing 18 fastened via a mount 17 to the corresponding side wall 13 of the connection part 1 and a piston rod 19 slidably arranged and hydraulically movable in the cylinder housing 18. The free ends of the piston rods 19 are connected to the drive housing 9 via a joint eye 20 and a corresponding mount 21. By retracting and extending the two piston rods 19 of the actuating cylinders 4 and 5, the housing part 2 with the support 6 rotatably mounted therein can thus be tilted relative to the connection part 1. The pivot drive, however, can also be formed by a hydraulic motor or another appropriate hydraulic drive.

The quick changer 9 designed for coupling an attachment or tool contains a housing 22 designed as a welded structure or as a cast part, which has first receptacles 23 open to one side for accommodating and holding a first pin-like coupling element on the tool side on one side, as well as second receptacles 24 open toward the bottom for accommodating and holding a second pin-like coupling element on the tool side on the other side. The first receptacles 23 open to one side are designed as claw- or fork-like. The second receptacles 24 to the other side toward the bottom have a curved lower support surface for supporting a pin-like coupling element. A manually or hydraulically operated locking device with two locking pins 26 movable inside holes 25, between an extended locking position and a retracted unlocking or change position, is provided on the second receptacles 24. The locking pins 26 can be moved manually via a manually pivotable lever or hydraulically between the retracted unlocking or change position and the extended locking position. Various tools or attachments can be connected to the quick changer 9, for example, tilting buckets, grapples, shears, compactors, magnets, hydraulic hammers or the like.

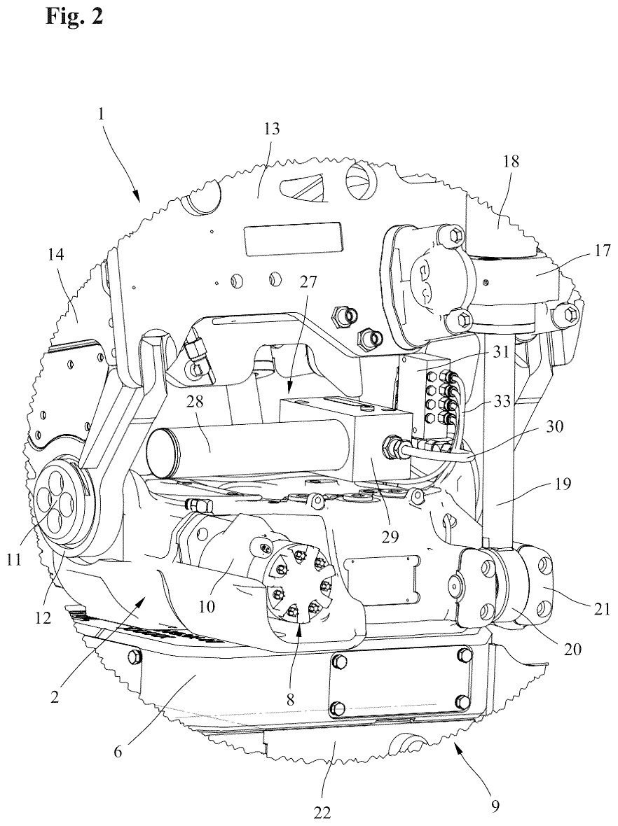

As can be seen in particular from the enlarged detailed view of FIG. 2, the rotary and swivel drive contains a central lubricant supply 27 with an automatically operable lubricant pump 29 provided with a lubricant reservoir 28 and a distributor unit 31 connected to the lubricant pump 29 via a supply line 30 for distributing the lubricant to different lubricating points 32. The lubricant reservoir 28, which is designed as a container for accommodating a sufficient amount of grease or a corresponding lubricant, is arranged on the lubricant pump 29 and can be mounted together with it on the housing part 2. A lubricating grease can be used as the lubricant, which is supplied to the lubricant reservoir 28. Several lubricant supply lines 33 leading to the individual lubricating points 32 are connected to the distributor device 31 for distributing the lubricant to the different lubricating points 32. The amount of lubricant required by the individual lubricating points 32 can be stipulated via the distributor unit 31.

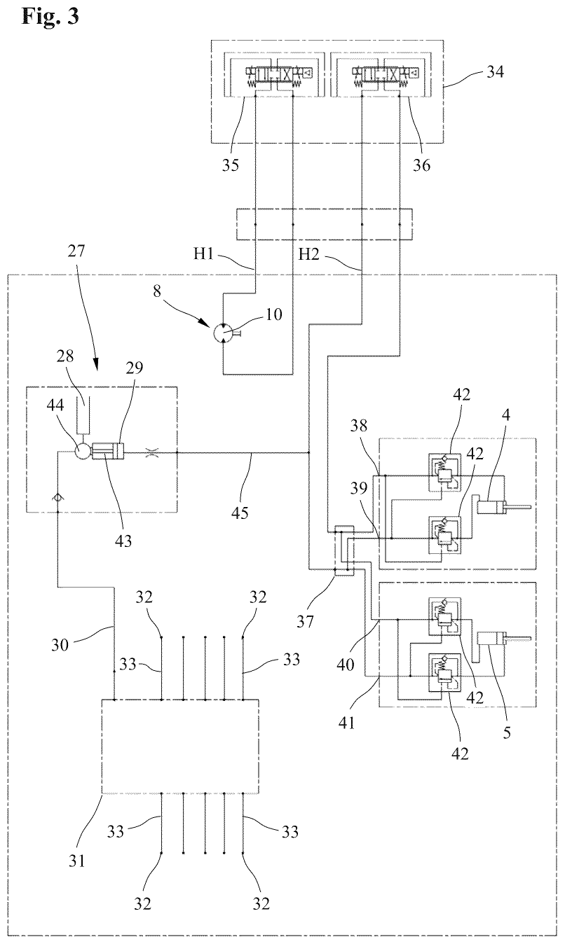

A circuit diagram of a hydraulic circuit arrangement for controlling the rotary drive 3 formed by the hydraulic motor 10, the pivot drive formed by the two actuating cylinders 4 and 5 and the lubricant pump 29 of the central lubricant supply 27 of the rotary and swivel drive is shown in FIG. 3. The circuit arrangement includes a control device 34 arranged, for example, on an excavator, which includes a first control valve 35 designed as a 4/3-way valve for controlling the first hydraulic circuit H1 used to control the hydraulic motor 10 of the rotary drive 3, and a second control valve 36 designed as a 4/3-way valve for controlling a second hydraulic circuit H2 used to control cylinders 4 and 5 of the pivot drive. The two actuating cylinders 4 and 5 of the pivot drive are controlled by the second hydraulic circuit H2 via branch 37 and four connections 38 to 41 so that the actuating cylinders 4 and 5 can be extended or retracted in opposite directions and the support 6 thus tilted around the pivot axis 3. A retarding brake check valve 42 is arranged upstream of the connections for retracting and extending the two actuating cylinders 4 and 5.

In the embodiment shown, the lubricant pump 29 is designed as a hydraulically operated lubricant pump with a hydraulically operated pump piston 43 and a lubricant amount regulation device 44 for adjusting the amount of lubricant delivered. The lubricant pump 29 is controlled by the hydraulic circuit H2 via a bypass line 45 branching off from the hydraulic circuit H2. This ensures that when the two actuating cylinders 4 and 5 for operating the pivot drive are activated, the lubricant pump 29 is also simultaneously activated to supply the lubricating points 32 with lubricant. The bypass line 45, however, can also branch off from the first hydraulic circuit H1 so that when the hydraulic motor 10 of the rotary drive 8 is activated, the lubricant pump 29 is activated. Regular lubrication can also thereby be ensured.

The invention is not limited to the rotary and swivel unit described in detail above. A central and automatically actuated lubrication device can also be used for pure rotary or swivel units.

### LIST OF REFERENCE NUMBERS

1 Connection part
2 Housing part
3 Pivot axis
4 First actuating cylinder
5 Second actuating cylinder
6 Support
7 Pivot axis
8 Rotary drive
9 Quick changer
10 Hydraulic motor
11 Journal
12 Bearing lug
13 Side wall
14 Crosspiece
15 First coupling element
16 Second coupling element
17 Mount
18 Cylinder housing
19 Piston rod
20 Joint eye
21 Mount
22 Housing
23 First receptacle
24 Second receptacle
25 Hole
26 Locking pin
27 Central lubricant supply
28 Lubricant reservoir
29 Lubricant pump
30 Supply line
31 Distributor unit
32 Lubricating point
33 Lubricant supply line
34 Control device
35 First control valve
36 Second control valve
37 Branch
38 First connection
39 Second connection
40 Third connection
41 Fourth connection
42 Retarding brake check valve
43 Pump piston
44 Lubricant amount regulation device
45 Bypass line

1. A rotary and/or swivel unit for attachment to a construction machine, which contains a connection part and a support arranged movable on the connection part for a tool or a quick changer for coupling a tool or attachment, in which the support is arranged on the connection part so as to be rotatable by a motor around an axis of rotation by means of a rotary drive and/or tiltable around a pivot axis by means of a pivot drive, wherein a central lubricant supply with an automatically actuated lubricant pump is provided with a lubricant reservoir for delivering a lubricant to different lubricating points of the rotary and/or swivel unit.

2. The rotary and/or swivel unit according to claim 1, wherein a housing part is arranged on the connection part, which is mounted so as to be pivotable around the pivot axis and tiltable by the pivot drive in which the support is rotatably mounted around an axis of rotation orthogonal to the pivot axis, and which can be rotated by a motor by means of the rotary drive.

3. The rotary and/or swivel unit according to claim 1, wherein the lubricant pump is connected via a supply line to a distributor unit to distribute the lubricant delivered by the lubricant pump to the different lubricating points.

4. The rotary and/or swivel unit according to claim 3, wherein the lubricant supply lines leading to the different lubricating points are connected to the distributor unit.

5. The rotary and/or swivel unit according to claim 1, wherein a lubricant amount regulation device is arranged on the lubricant pump for adjusting the amount of lubricant delivered by the lubricant pump when the lubricant pump is activated.

6. The rotary and/or swivel unit according to claim 2, wherein the lubricant pump is arranged on the housing part.

7. The rotary and/or swivel unit according to claim 1, wherein the lubricant pump is designed as a hydraulically operated lubricant pump with a hydraulically operated pump piston.

8. The rotary and/or swivel unit according to claim 1, wherein the lubricant pump is activated by controlling the pivot drive or by controlling the rotary drive.

9. The rotary and/or swivel unit according to claim 8, wherein the lubricant pump is connected via a bypass line to a pivot drive hydraulic circuit for controlling the pivot drive, a rotary hydraulic circuit for controlling the rotary drive or another hydraulic circuit.

10. The rotary and/or swivel unit according to claim 9, wherein the rotary drive includes a hydraulic motor that can be controlled by the rotary drive hydraulic circuit.

11. The rotary and/or swivel unit according to claim 9, wherein the pivot drive is formed by two double-acting actuating cylinders movable in opposite directions and controllable by the pivot drive hydraulic circuit.

12. The rotary and/or swivel unit according to claim 1, wherein a quick changer designed for connecting a tool or attachment is arranged on the support.

13. The rotary and/or swivel unit according to claim 1, wherein the connection part contains two spaced-apart pin-like coupling elements for coupling the connection part to a quick changer.
